(19) United States
(12) Patent Application Publication
(10) Pub. No.: US 2018/0096111 A1
(43) Pub. Date: Apr. 5, 2018

(54) PREDICTIVE TELEREHABILITATION TECHNOLOGY AND USER INTERFACE

(71) Applicants: Richard Wells, Ada, MI (US); Timothy R. Price, East Grand Rapids, MI (US); Ted Spooner, Warsaw, IN (US); Dave Van Andel, Spring Lake, MI (US); Travis Dittmer, Grand Rapids, MI (US); John Kotwick, Grand Rapids, MI (US); Jason Leighton, Portland, OR (US)

(72) Inventors: Richard Wells, Ada, MI (US); Timothy R. Price, East Grand Rapids, MI (US); Ted Spooner, Warsaw, IN (US); Dave Van Andel, Spring Lake, MI (US); Travis Dittmer, Grand Rapids, MI (US); John Kotwick, Grand Rapids, MI (US); Jason Leighton, Portland, OR (US)

(21) Appl. No.: 15/723,833

(22) Filed: Oct. 3, 2017

Related U.S. Application Data
(60) Provisional application No. 62/403,482, filed on Oct. 3, 2016.

(51) Int. Cl. G06F 19/00; G06Q 10/10

(52) U.S. Cl. CPC G06F 19/3481; G06F 19/3406; G06F 19/363; G06Q 10/1093

(57) ABSTRACT

Embodiments of a system and method for evaluating or predicting therapy adherence are generally described herein. A system may include a display and a processor connected to the display to provide a user interface, including a calendar with a plurality of activities of a protocol. The plurality of activities may include exercises, education, questionnaires, etc., which may be presented on particular days or at particular times. Patient adherence to the protocol may be determined, and the display may provide information related to the patient adherence to a clinician. The display may provide a prediction about future patient adherence. The processor may, based on a determination about future patient adherence or past patient adherence, automatically modify the protocol. After the protocol is modified, the calendar may be updated and the display may show the updated calendar.

### CLAIM OF PRIORITY

This application claims the benefit of U.S. Provisional Patent Application Ser. No. 62/403,482, filed on Oct. 3, 2016, the benefit of priority of which is claimed hereby, and which is incorporated by reference herein in its entirety.

### BACKGROUND

Telerehabilitation systems are typically used to remotely assess or monitor patients engaged in rehabilitation activities. Current telerehabilitation systems are often limited or not used for occupational or physical therapy due to the remote nature of telerehabilitation. Occupational or physical therapy includes exercises or activities to recover from an injury, surgery (for example, total knee arthroplasty, total hip arthroplasty, partial knee arthroplasty, hip resurfacing, or knee arthroscopy, or other orthopedic surgery), or to otherwise improve mobility. Often, patients fail to complete activities associated with rehabilitation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a clinician user interface in accordance with some embodiments.

FIG. 2 illustrates a patient user interface in accordance with some embodiments.

FIG. 3 illustrates an exercise creation system in accordance with some embodiments.

FIG. 4 illustrates a telerehabilitation system in accordance with some embodiments.

FIG. 5 illustrates a flow chart showing a technique for therapy adherence prediction in accordance with some embodiments.

FIG. 6 illustrates generally an example of a block diagram of a machine upon which any one or more of the techniques discussed herein may perform in accordance with some embodiments.

### DETAILED DESCRIPTION

Systems and methods for displaying a user interface for improving patient outcomes are described herein. The systems and methods herein describe a clinician user interface and a patient user interface for telerehabilitation. The user interfaces described herein may include options for video creation, animation creation, video or animation playback, message interaction, notifications (e.g., push), calendar displays, feedback submission or viewing, or the like. The clinician user interface may include a component to configure or view a protocol, including exercises making up a routine. The protocol may include education, questionnaires, etc., for example, shown in a calendar view. The user interfaces may be used to collect data and, along with other received data, predict behavior.

A calendar may be presented to a patient on a patient user interface, the calendar including a plurality of activities of a protocol, which may be displayed on specific days, at specific times, or the like. For example, an exercise may be scheduled for a Tuesday and a Thursday, with education scheduled on Monday and Wednesday (e.g., education about how to perform exercises, why exercises are needed, how to prepare for or recover from surgery, additional information about diet, rehab, activities to engage in or refrain from, such as walking up stairs, or the like). Other activities from the protocol may be displayed, such as a questionnaire on Friday to evaluate the patient's thoughts, feelings, pain rating, impression of exercises or education, or the like.

In an example, the calendar may include a plurality of exercises, for example, three in a week. After a first day where one of the exercises is scheduled, information related to performance of the exercise, such as number of reps completed, weight used, pain rating, range of motion, or the like, may be recorded or stored. Using this information, which may be determined from a patient questionnaire, a camera, a wearable sensor device, a clinician report (e.g., a clinician that supervised the exercise), or a combination of one or more of the above, a component on a clinician user interface may display data related to patient adherence. For example, the data may indicate that the patient has not adhered to the protocol. In an example, the data may be used to determine a likelihood that the patient will adhere to a future aspect of the protocol (e.g., an exercise, education, a clinician visit, etc.). In an example, a processor may determine that the patient is unlikely to adhere to a future aspect of the protocol. In response to this determination, the processor may automatically update the protocol (e.g., modify aspects of the protocol such as an exercise or education, such as by moving, reducing, changing, etc. a day, time, duration, or other aspects of the protocol), or, additionally or alternatively, notify the clinician of the determination that the patient is unlikely to adhere to the currently prescribed protocol. After the protocol has been updated, either automatically or by a clinician in response to an indication that the patient has not or will not adhere to an aspect of the protocol, the calendar may be updated and displayed on the patient user interface.

Prediction techniques described herein may output patient-based predictions using demographic factors, such as age, weight, height, gender, comorbidities/illness, and implanted medical device, among others. In an example, therapy performance, such as information related to previously performed or not performed exercises, education taken by the patient, or other aspects of a protocol performed (or not performed to a certain extent) by the patient, may be used to perform predictions. The prediction techniques may determine a degree of follow up that is appropriate or necessary for the patient. In an example, the amount of follow up may be based on patient expectations or selections, clinical need as designated by a clinician, or using machine learning. Specific types of motivation or notification may be determined by the prediction techniques. The prediction technique may determine and output a likelihood that a patient will adhere to a telerehabilitation schedule. This information may be displayed on a user interface, such as by displaying an alert (e.g., an alert to the clinician when the patient misses an exercise or routine, an alert to the patient as a reminder, an alert to a third party caregiver, etc.).

A user interface may be used to create a new profile, such as a patient profile or a clinician profile. The new profile may be created with a predetermined code, password, or similar authentication mechanism, that may grant access to a specific user interface or material. For example, a patient may be able to create a patient profile and access the patient's information, including exercises, routines, protocols, calendars, feedback, or the like. The patient information may have been previous collected and stored in the electronic health record of the clinician. A clinician may be able to create a clinician profile and access information for the clinician's patients. A caregiver may be able to create a profile to access patient information for a patient under the care of the caregiver. In an example, responsibilities for a clinician, caregiver, or patient may be displayed on the user interface.

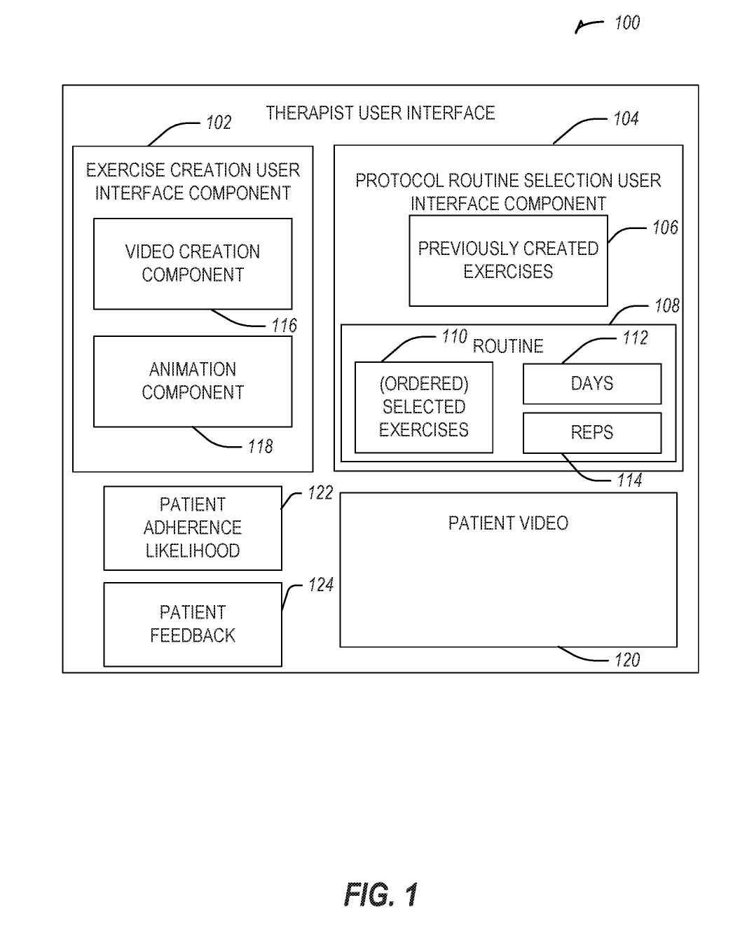

FIG. 1 illustrates a clinician user interface 100 in accordance with some embodiments. The clinician user interface 100 includes an exercise creation user interface component 102, a protocol routine selection user interface component 104 and a patient video component 120. In an example, the clinician user interface 100 includes a patient adherence likelihood component 122, or a patient feedback component 124. These components may be displayed individually or in combination. In an example, the clinician user interface 100 is used to prescribe therapy, such as physical or occupational therapy to a patient.

The exercise creation user interface component includes a video creation component 116 and an animation component 118. The video creation component 116 may be used to create a new video exercise. The animation component 118 may be used to create a new animation exercise. The protocol routine selection user interface component 104 includes a list of previously created exercises 106 and a routine creator 108. The routine creator 108 includes a display of selected exercises 110, which may be ordered or unordered. The routine creator 108 includes an input for number of days 112 and an input for number of reps 114. The routine creator 108 may be used to build a routine.

To build a routine, a clinician may select an exercise from a predefined list of exercises in the previously created exercises 106. An exercise may be added to a timeline (e.g., selected exercises 110), and the clinician may designate a number of reps 114 or a duration for how long to do an exercise. The clinician may use the animation component 118 to preview an animation exercise or the video creation component 116 to preview a video exercise, the animation exercise or the video exercise created by the clinician or from the previously created exercises 106. The clinician may also use the animation component or the video creation component to design a new exercise and save the new exercise to the list of exercises.

The clinician may rename an exercise to give context to the patient. The clinician may search the list of previously created exercises 106 by key name, by body part, by procedure done, by animation or clips (video clips may augment or replace the animations), or the like. The clinician may save the routine, name the routine, add a description of the routine, add a category for the routine, or select whether to share the routine with other clinician or the public. The clinician may search based on categories, names, browse, etc. The routine may be saved to a network. The routine may be saved to an individual clinician or patient account, and changed by the individual clinician to suit a specific patient need while leaving previous versions of the routine (or exercises) unchanged. When changing an exercise or a routine, the clinician may change the exercise or routine for all of the clinician's patients, change it for future uses, or change it for a specific patient.

The protocol routine selection user interface component 104 may include a protocol builder. A protocol may include a set of routines, questionnaires, education, assessments, outcome measures, or other actions for performance by a patient. For example, a calendar may be created for a patient with a first day of surgery, and a routine may be added for that day or the next day that includes education, rest, ice, elevation, etc. Then when the patient may start physical therapy on a subsequent day, the subsequent day may include exercises of a routine.

When adding a protocol, the clinician may add a routine, select from public routines, private routines, etc., may search by name, category, or the like, or may preview exercises. The clinician may select routine type, specified routine, repeat (e.g., every 2 days, every day, every 12 hours, etc.), add number of times (e.g., 3 times, total number of times—for example 2 days for 6 total days for 3 times), etc. The clinician may add days or remove days in between routines. The clinician may save the protocol using the protocol routine selection user interface component 104, which includes the routines, education, etc., for the calendar for a number of times/days, etc. The protocol may be published by sending it to a patient user interface or calendar. The patient may be alerted or notified that new activities are available, that a routine is upcoming, that exercises need to be done, or of similar upcoming actions. The patient may see a calendar event or calendar displayed including these events.

In an example, a machine learning technique (e.g., as provided by a cloud service, via a remote server, or the like) may be used to determine whether to notify a clinician using the clinician user interface 100. For example, when a patient missed a specified number of days in a row of exercises, routines, or protocol elements, then the clinician may be notified. In another example, when a surgery is completed, the clinician may be notified within a few hours if the patient has not done an activity. In an example, a patient user interface may notify the patient when there are situations that the patient needs to move. The clinician user interface 100 may recommend that the clinician cause a notification or alert to be sent to a patient if the patient has not moved in a while or has not done an exercise. In an example, a wearable device may be used to notify a patient or a clinician. In another example, email, or an audible alert may be used. In yet another example, the clinician user interface 100 may alert a third party (e.g., a therapist, a caregiver, a child, or a parent, a doctor, or the like). The patient and clinician may communicate using messages, such as using text, audio, video, or the like. A message video may be recorded using the video creation component 116. The patient video component 120 may be used to display a video of a patient performing an exercise or a routine. The clinician may make comments on the video and submit them using the patient feedback component 124.

In an example, a clinician may be assigned to a group or groups, which may give the clinician access to the previously created exercises 106, a patient or a list of patients, the exercise creation user interface component 102, etc. In an example, the clinician may add a patient to a group or groups, move a patient among groups, etc. In an example, a particular clinician may access all patients in a group, or just within the particular clinician's group, may see others to cover for another clinician, or may not be able to see any patients outside the group (e.g., outside the coverage, or to prevent a privacy or HIPAA violation). In an example, a clinician may include a therapist, such as a physical therapist.

In an example, a clinician may virtually sign a document using the clinician user interface 100. For example, the clinician may attest that the clinician has reviewed a patient video (e.g., an exercise or a routine). The virtual signature may be used to create billing, close out a patient record, establish patient-to-clinician interaction (e.g., the patient may receive a notice that the clinician reviewed the video), or the like. A virtual signature may be logged and verified to provide a record of clinician-patient interactions as a measure to ensure proper follow up care is being provided to the patient.

In an example, the clinician user interface 100 may include a calendar view of a patient calendar. The calendar view may detail patient progress regarding a routine or protocol. The clinician user interface 100 may include a mini-patient user interface view to show the patient what a patient user interface looks like directly from the clinician user interface 100 without needing to log out and have the patient log in.

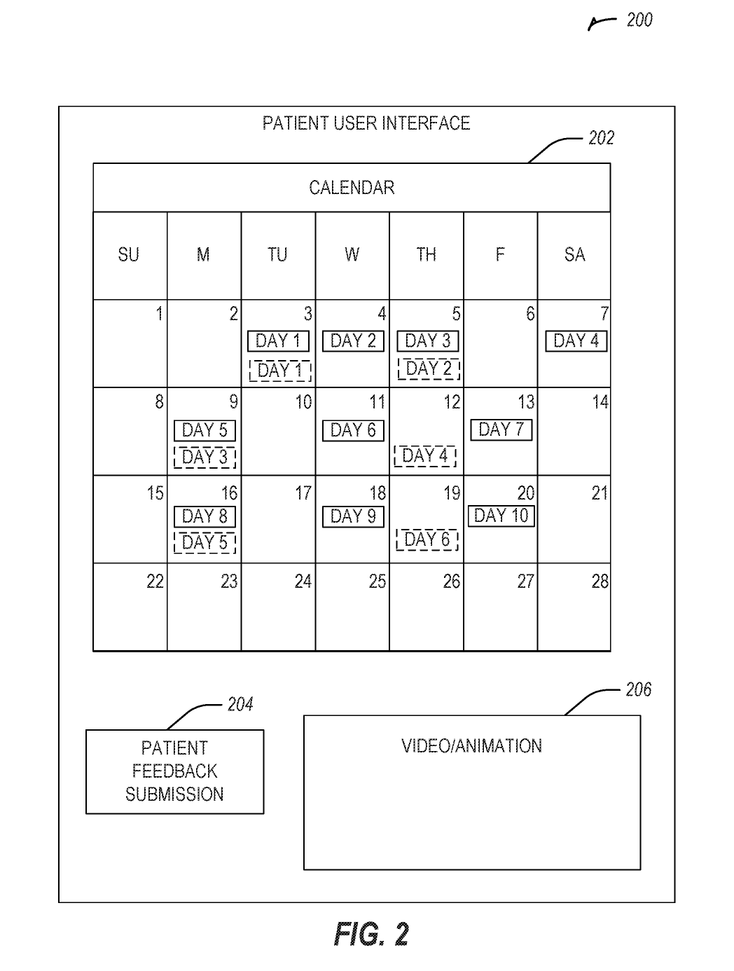

FIG. 2 illustrates a patient user interface 200 in accordance with some embodiments. The patient user interface 200 includes a calendar 202, a patient feedback submission 204, and a video/animation viewer 206, each of which may be displayed individually or in combination.

The calendar 202 includes days, exercises, routines, protocols, etc. For example, the days displayed in solid line (e.g., on the 3rd, the 4th, the 5, etc.) may make up an initial routine. In an example, a likelihood of patient adherence to a routine or protocol may be determined. In another example, information related to patient adherence may be presented to a clinician, for example on a clinician user interface. The information related to patient adherence may include information about past adherence or predicted adherence for future activities of a protocol. The patient user interface 200 may determine the likelihood or present adherence data using information about a patient, such as therapy performance (e.g., adherence), patient demographics (e.g. age, weight, height, personality type, personal motivation), location, comorbidities, pain ratings, difficulty of the routine or protocol, difficulty of exercises, or the like. In another example, the likelihood may be determined at a server remote from the patient user interface 200. The information used in prediction or to display adherence may include observed patient behaviors, such as pattern of delinquency on certain days of the week, general pattern of delinquency, patient actions (e.g., relative success or failure of particular exercises or movements), or the like. When the likelihood falls below a threshold (e.g., more unlikely than likely, or 75% likely, or 33% likely, etc.), the patient user interface 200 may automatically adjust the routine or protocol to increase the likelihood of patient adherence. For example, the patient user interface 200 may adjust the routine or protocol to the days shown in dotted lines (e.g., Day 1 on the 3rd, Day 2 on the 5th, Day 3 on the 9th, etc.) to be less strenuous or daunting for a patient. In an example, the clinician may be presented with adherence information about the patient. The patient may be more likely to adhere to the routine or protocol if there are fewer days, reps, exercises, or similar alterations determined to increase adherence based on demographic, therapy performance, or similar factors. In another example, if the likelihood that the patient will adhere to the routine or protocol is high (e.g., more likely than not, or over a certain percentage), the routine or protocol may be left alone, or a number of reps, exercises, or days may be increased, such as over time or every other day. In an example, when the likelihood falls below a threshold, a clinician may be alerted or notified so that the clinician may adjust the routine or protocol. In another example, a clinician may input more than one routine or protocol and have the patient user interface 200 automatically determine which routine or protocol has the highest likelihood of patient adherence.

The patient feedback submission 204 may receive patient input on an exercise, routine, protocol, clinician, or other aspect of the patient's care. In an example, the patient feedback submission 204 includes a pain submission form. Patient feedback may be collected on a particular exercise or routine as a whole, including, for example, a pain rating before, during, or after, a difficulty rating for an exercise or routine, or a rating for an exercise or routine.

The patient user interface 200 may be connected to a camera, such as a camera with an infrared sensor, that may capture a patient performing an exercise or a routine. In an example, the camera may be used to automatically count reps of an exercise or routine, and report whether an exercise has been successfully completed, a number of reps performed, or a duration performed. The success or failure of the patient may be reported on the patient user interface 200. Encouragement may be given to the patient using the patient user interface 200 after the report of success or failure, such as encouragement for successful completion of an exercise or routine, or encouragement to for an effort or to try again when failing. In an example, a wearable device (e.g., a fitness device) or other fitness monitoring device may be used to detect patient compliance with an exercise or a routine. For example, when a routine includes running as an exercise, a wearable device may detect that a patient has run during a day and report to the patient user interface 200 the successful completion of the exercise.

The video/animation viewer 206 may display video or animation, such as a video or animation of an exercise. The video or animation displayed may be of an exercise or routine, such as one created or selected by a clinician for the patient. In an example, the video or animation displayed may include clinician voiceover instructions or text to indicate instructions.

The patient user interface 200 may include education components on the calendar 202. For example, a routine for a day on the calendar 202 may include education information (e.g., do not eat the 8 hours before surgery, or make sure to drink water before and after exercising), exercises, or the like.

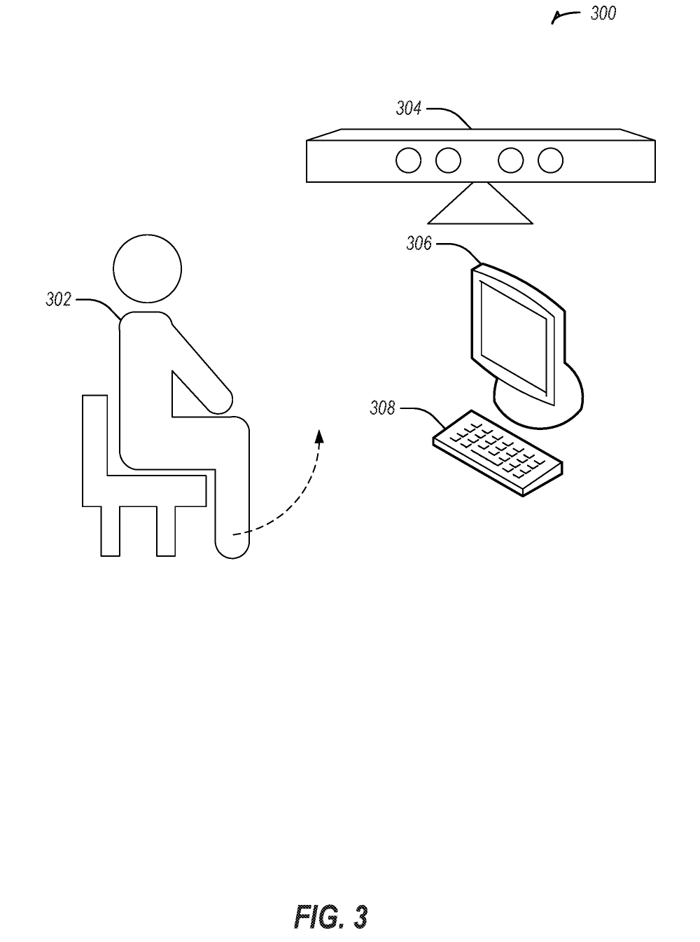

FIG. 3 illustrates an exercise creation system 300 in accordance with some embodiments. In an example, the exercise creation system includes a clinician 302, a video capture device 304, a display device 306, and an input device 308. The clinician 302 may perform an exercise, which is captured by the video capture device 304 and displayed in the display device 306 (e.g., using the clinician user interface 100 of FIG. 1). The input device 308 may be used to edit or augment the displayed exercise, or to select one or more exercises for a routine. The exercise creation system 300 may automatically edit the captured video to excise extraneous portions that come before or after the exercise performed by the clinician. In an example, a series of exercises may be performed by the clinician and captured by the video capture device 304, and the exercise creation system 300 may split the captured video of the series of exercises into individual exercise videos.

Aspects of the exercise may be selected using the input device 308. The selected aspects may include a starting position, an ending position, or a transition motion. When a starting position is selected, the display device 306 may display the selection at the appropriate time in the captured video of the exercise. For example, a circle may be drawn around a displayed body part (e.g., a foot, a hand, etc.), which may be displayed in the captured video for the exercise. Similarly, an ending position may be highlighted. When a transition motion is selected, a path may be displayed during the captured video that tracks with the selection. The starting position, ending position, or the transition motion may include more area on the captured video than the body part occupies (e.g., a radius around a center point of the body part).

In an example, the exercise creation system 300 may be calibrated using the video capture device 304. The video capture device 304 may use infrared light to detect the clinician 302 in a field of view. The exercise creation system 300 may evaluate the detection to identify joints, limbs, appendages, a head, etc., of the clinician 302. These identified body parts may be used with later captured video of an exercise to label specific body parts.

After a video of an exercise is captured by the video capture device 304, the clinician 302 (or another user) may edit the captured video. In an example, the clinician 302 may select portions of a captured video and add tags, such as “introduction,” “exercise,” “first repetition,” “second repetition,” “outro,” or the like. In an example, a single repetition captured may be repeated in an edited video to show multiple repetitions for patient viewing.

A final edited video may be created for an exercise. The final edited video may be named and given a category tag, such as a body part, a muscle group, a post-surgery type designation, a patient-specific tag, or the like. The final edited video may be saved for later use in constructing a routine, such as by the clinician 302. In another example, the final edited video may be saved to a database to be shared with other users (e.g., other users caring for a patient shared with the clinician 302, other clinicians in a company, group, or hospital, publicly, or the like).

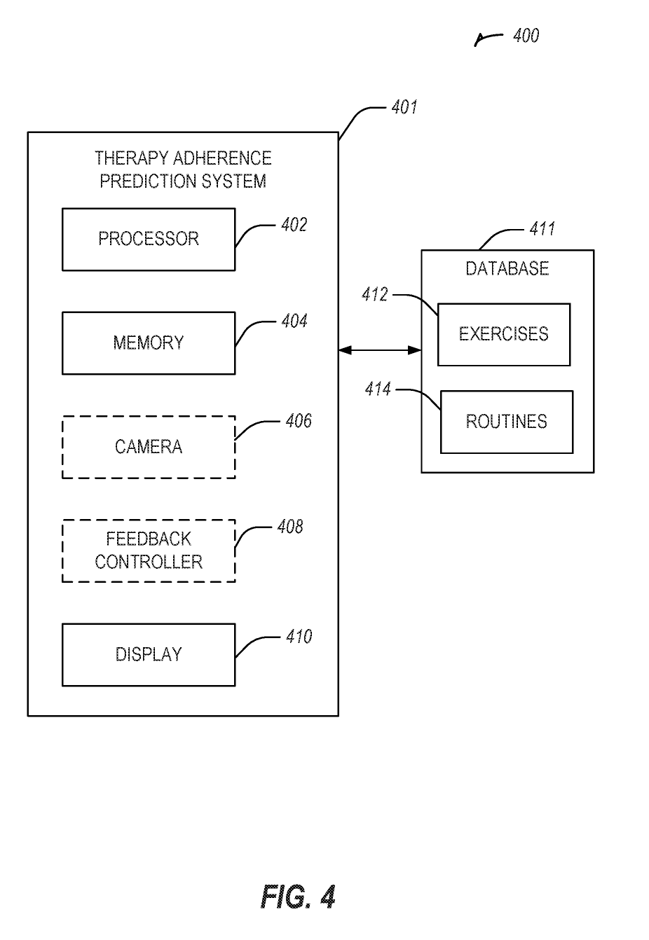

FIG. 4 illustrates a telerehabilitation system 400 in accordance with some embodiments. The telerehabilitation system 400 includes a therapy adherence prediction system 401 that includes a processor 402, memory 404, a display 410, and optionally a camera 406 or a feedback controller 408. The therapy adherence prediction system 401 may be connected to a database 411. The database may include information about exercises 412 or information about routines 414. For example, the information about exercises 412 may include previously submitted exercises, including video or animation, names for exercises, patient assignations, clinician creation notes or attributions, metadata about exercise creation, or the like. The information about routines 414 may include complete routines, partial routines, lists of exercises in routines, routines by assignment to patients or by clinicians, number of reps or days, metadata about routine creation, or the like.

The therapy adherence prediction system 401 may use the processor 402 to provide a clinician user interface on the display 410. The processor 402 may be networked, such as on a server, in the cloud, on multiple servers, may include a plurality of processors (e.g., dual core, quad core, etc.), or the like. The clinician user interface may include an exercise creation user interface component or a protocol routine selection user interface component. In an example, the exercise creation user interface component includes a video creation component or an animation component. The video creation component may be selectable, for example, to record video of a clinician performing an exercise. The animation component may be selectable to create an animated exercise. The clinician user interface may display on the display 410, a video of a patient performing an exercise. In an example, the plurality of exercise items include at least one exercise from a predefined list and at least one exercise created using the exercise creation user interface component. The predefined list may be stored in the database 411 (e.g., in the information about exercises 412), in the memory 404, or the like. The at least one exercise created may be created using the therapy adherence prediction system 401.

The processor 402 may receive selection of a plurality of exercise items, such as via the protocol routine selection user interface component to create a routine for a patient. The plurality of exercise items may include exercises created using the therapy adherence prediction system 401, stored in the database 411, or the like. The routine may include the plurality of exercises in an order. In an example, the processor 402 may create a patient protocol, the patient protocol including information about the routine, a specified number of days to perform the routine, a specified number of times per day for each exercise in the plurality of exercises in the routine, or at least one of education information, a questionnaire (e.g., a Knee Injury And Osteoarthritis Outcome Score (KOOS), a Hip Disability And Osteoarthritis Outcome Score (HOOS), a KOOS Joint Replacement (KOOS JR), a HOOS Joint Replacement (HOOS JR), a Western Ontario and McMaster Universities Osteoarthritis Index (WOMAC), or the like), or an assessment.

The processor 402 may automatically populate a patient calendar to be displayed on a patient user interface. The patient calendar may include information about the routine, the plurality of exercise items, days, reps, or the like. In an example, automatically populating the patient calendar may include automatically populating the patient calendar using the patient protocol. The processor 402 may receive demographic or therapy performance information for the patient to determine adherence. The demographic information or the therapy performance information may be stored in the database 411, received from the patient, input by the clinician using the display 410, stored in the memory 404, or retrieved from another location (e.g., a third party server, the cloud, a wearable device, etc.).

The processor 402 may determine a likelihood that the patient will adhere to the routine or may determine adherence data, such as by using the demographic information or the therapy performance information. The likelihood or adherence data may be displayed using the clinician user interface on the display 410. The processor 402 or the clinician may modify the patient calendar based on the likelihood or the adherence information. In an example, modifying the patient calendar includes reducing a number of reps, a number of days, or a number of exercises for the routine or protocol based on the likelihood transgressing (e.g., falling below) a threshold. For example, when the patient is determined to more likely than not fail to perform the routine or exercises for a number of reps or days, the number of reps or days may be reduced so as not to overwhelm the patient or make the patient more likely to succeed at completing a routine, protocol, or exercise.

In an example, the therapy adherence prediction system 401 may receive, using the processor 402, patient feedback to be stored in the memory 404 or the database 411. The patient feedback may be received using the display 410, a patient user interface, or the like. The patient feedback may include information about an exercise, a routine, a pain rating (e.g., before, after, or during an exercise, routine, or protocol), a protocol, a difficulty rating for a routine, exercise, or protocol, or the like. In an example, the processor 402 may provide, such as via the clinician user interface on the display 410, the patient feedback. The patient feedback provided may include a recommendation for an adjustment to the routine, an exercise, or a protocol, such as by using the feedback controller 408. In an example, the optional camera 406 may be used to capture exercises performed by the clinician for use in creation of the plurality of exercises. The patient may also provide feedback orally through the user interface, and said feedback may be provided to the clinician in its original format (e.g., audio, video) or fed into a transcription service for translation into text. The textual form of the feedback may be provided to the clinician in the form of a message or notification. The audio or video form of the patient feedback may also be provided to a machine learning tool (e.g., via a remote server or a machine learning service) to extract actionable insights from the patient feedback that are not apparent to the clinician from the text alone, (e.g., identification of a grimace to indicate high possibility of pain when the patient does not report pain).

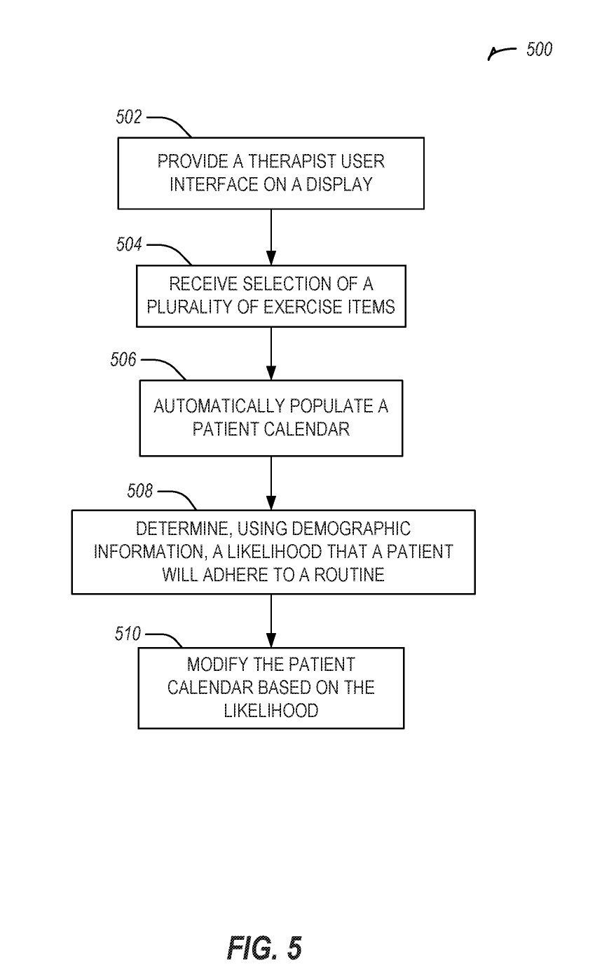

FIG. 5 illustrates a flow chart showing a technique for therapy adherence prediction in accordance with some embodiments. The technique 500 includes an operation 502 to provide a clinician user interface on a display. The clinician user interface may include an exercise creation user interface component or a protocol routine selection user interface component.

The exercise creation user interface component may include a video creation component or an animation component. The video creation component may be selectable to record video, such as video of a clinician performing an exercise. The animation component may be selectable to create an animated exercise. The protocol routine selection user interface component may be used to select exercises for a routine. In an example, the protocol routine selection user interface may be used to select items for a protocol. A protocol may include information about the routine, a specified number of days to perform the routine, a specified number of times per day for each exercise in the plurality of exercises in the routine, and at least one of education information, a questionnaire, an assessment, or the like.

In an example, the clinician user interface may be used to display a video of the patient performing an exercise, such as an exercise of a plurality of exercises, or a routine. The technique 500 includes an operation 504 to receive selection of a plurality of exercise items. The selection may be received via the protocol routine selection user interface component to create a routine for a patient. The plurality of exercise items may include an exercise from a predefined list or an exercise created using the exercise creation user interface component. The routine may include the plurality of exercise items in an order.

The technique 500 includes an operation 506 to automatically populate a patient calendar. The calendar may be displayed on a patient user interface. The calendar may include information about the routine, the plurality of exercises, a protocol, or the like. The calendar may be populated automatically with the routine, exercises, the protocol, or the like. The technique 500 includes an operation 508 to determine, such as by using demographic information or therapy performance information, a likelihood that a patient will adhere to a routine or adherence information (e.g., past adherence of the patient to aspects of the protocol or predictions about the adherence of the patient to future aspects of the protocol). The demographic information or adherence information may be received from the patient, from the clinician, from a patient user interface, from a clinician user interface, from a database, from a wearable device, or similar source of information about the patient. For example, demographic information may include age, weight, height, gender, illness, implant type, or personality type. Other information such as location, pain ratings, difficulty of the routine or protocol, difficulty of exercises, therapy performance, or the like may also be used. In an example, the likelihood may be determined based at least in part on a number of exercises, a number of reps, or a number of days in the routine.

The likelihood that a patient will follow an exercise, a routine, or a protocol (e.g., predicted adherence) may be determined, such as by using various patient attributes (e.g., demographics, therapy performance, etc.). Example demographics may include information about the patient such as age, weight, or height, and other information such as a time of year, location (e.g., from a geotagged device), or the like may be used. In an example, the technique 500 includes automatically creating, such as by using machine learning, recommended exercises for a routine. In another example, the technique 500 includes automatically creating recommendations for treatment, education, questionnaires, or the like. To determine the likelihood may include additional factors, such as outside exercise (e.g., not part of the routine), actual adherence, past patient adherence to the same or similar routines, protocols, or exercises, a clinician rating, or the like.

In an example, the technique 500 may include performing a recurring determination of likelihood of adherence of the patient to the routine. The recurring determination may include continuously monitoring the patient to determine if the routine may be modified, such as to make the routine less difficult (e.g., remove a number of reps, a number of days, or a number of exercises, or change the type of motion or difficulty of the exercises) if the updated likelihood indicates the patient is unlikely to complete the routine. In another example, the routine may be made more difficult (e.g., increasing a number of reps, a number of days, or a number of exercises, or changing the type of motion or difficulty of the exercises) if the patient has a high likelihood (e.g., over 50%, 75%, 95%, etc.) to complete the routine. In this example, the clinician may preset escalating routines to automatically increase or decrease difficulty or change routine focus over time for the patient based on the recurring determinations of likelihood. The technique 500 may include determining the likelihood using patient demographics, such as age, weight, height, personality type or personal motivation, therapy performance, or location, pain ratings, difficulty of the routine or protocol, difficulty of exercises, or the like. Adherence information may include observed patient behaviors, such as pattern of delinquency on certain days of the week, general pattern of delinquency, patient actions (e.g., relative success or failure of particular exercises or movements), or the like. In an example, an exercise or movement may be tracked using a camera, such as the Kinect from Microsoft of Redmond, Wash. or a wearable device (e.g., a watch or other wearable with sensors, such as an accelerometer or gyroscope). The camera or wearable device may be used to track adherence. In an example, information captured by the camera or wearable device may be used by a clinician to determine whether an exercise, movement, or other aspect of a protocol is to be changed. For example, the camera may capture information indicative of range of motion of the patient, which may be used by the clinician to modify education related to increasing range of motion for the patient.

The technique 500 includes an operation 510 to modify the patient calendar based on the likelihood. The patient calendar may be updated to include a modified routine. The modified routine may be a modification to the routine based on the likelihood transgressing (e.g., falling below) a threshold. The patient calendar may be updated to reduce a number of reps, a number of days, or a number of exercises, reflected in the modified routine.

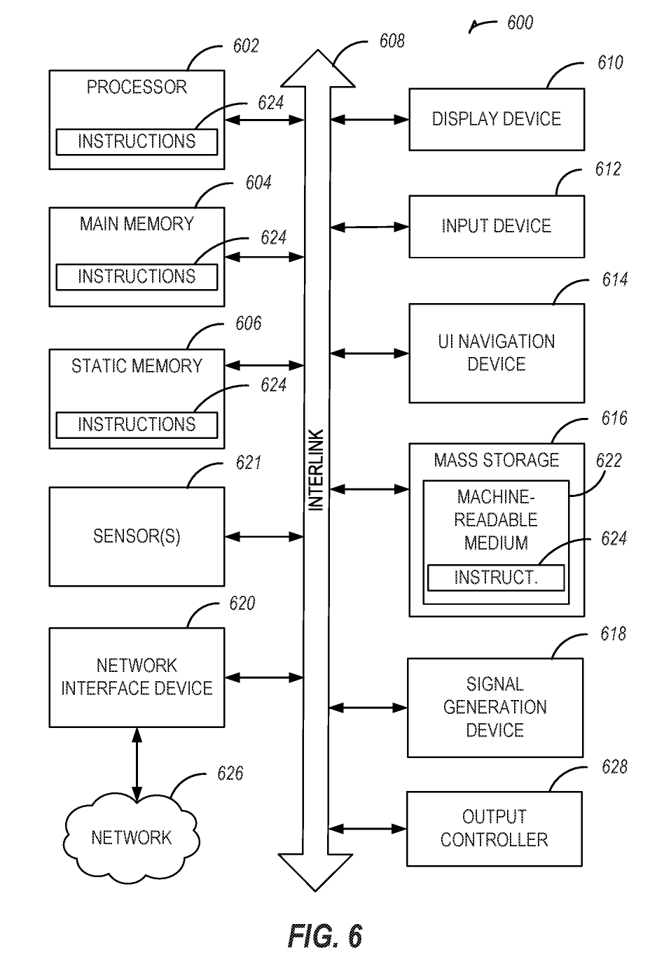

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

In an example, machine 600 may be used to display a patient user interface, a clinician user interface, or other user interfaces described herein. In another example, machine 600 may be used to perform machine learning techniques or determine a likelihood that a patient will adhere to a routine or protocol, such as based on patient adherence information. Machine 600 may be used to modify a routine or protocol, or to automatically update a patient calendar. A patient calendar may be displayed on machine 600. In an example, machine 600 may be a personal computer, a cloud service, a mobile device (e.g., a smartphone or a tablet), a wearable device, or the like.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, IEEE 802.11.1 standards known as Bluetooth®, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### Various Notes & Examples

Each of these non-limiting examples may stand on its own, or may be combined in various permutations or combinations with one or more of the other examples.

Example 1 is a system for predicting therapy adherence, the system comprising: a display; and a processor connected to the display, the processor to: provide a clinician user interface on the display, the clinician user interface including an exercise creation user interface component and a protocol routine selection user interface component; receive selection of a plurality of exercise items via the protocol routine selection user interface component to create a routine for a patient; automatically populate a patient calendar to be displayed on a patient user interface, the patient calendar including information about the routine; receive patient adherence information for the patient; determine, based at least in part on the patient adherence information, a likelihood that the patient will adhere to the routine; modify the routine to create a modified routine based on the likelihood transgressing a threshold; and update the patient calendar to include, the modified routine.

In Example 2, the subject matter of Example 1 includes, wherein the exercise creation user interface component includes a video creation component and an animation component, the video creation component selectable to record video of a clinician performing an exercise and the animation component selectable to create an animated exercise.

In Example 3, the subject matter of Examples 1-2 includes, wherein the clinician user interface is configured to display a video of the patient performing an exercise.

In Example 4, the subject matter of Examples 1-3 includes, wherein the plurality of exercise items include at least one exercise from a predefined list and at least one exercise created using the exercise creation user interface component.

In Example 5, the subject matter of Examples 1-4 includes, wherein the routine includes the plurality of exercise items in an order.

In Example 6, the subject matter of Examples 1-5 includes, wherein the processor is further to create a patient protocol, the patient protocol including information about the routine, a specified number of days to perform the routine, a specified number of times per day for each exercise in the plurality of exercise items in the routine, and at least one of education information, a questionnaire, or an assessment.

In Example 7, the subject matter of Example 6 includes, wherein to automatically populate the patient calendar includes to automatically populate the patient calendar using the patient protocol.

In Example 8, the subject matter of Examples 1-7 includes, wherein the patient adherence information is received via at least one of the patient user interface, the clinician user interface, or information stored in a database, and includes demographic information for the patient.

In Example 9, the subject matter of Examples 1-8 includes, wherein to determine the likelihood, the processor is to determine the likelihood that the patient will adhere to the routine based at least in part on a number of exercises, a number of reps, or a number of days in the routine.

In Example 10, the subject matter of Examples 1-9 includes, wherein to modify the routine, the processor is to reduce a number of reps, number of days, or number of exercises in the routine and wherein to update the patient calendar, the processor is to reduce the number of reps, the number of days, or the number of exercises shown in the patient calendar.

In Example 11, the subject matter of Examples 1-10 includes, wherein the processor is further to receive patient feedback collected using the patient user interface, the patient feedback including information about at least one of an exercise of the plurality of exercise items, the routine, a pain rating, or a difficulty rating for the routine.

In Example 12, the subject matter of Example 11 includes, wherein the processor is further to provide, via the clinician user interface, the patient feedback including at least one recommendation for an adjustment to the routine.

Example 13 is a method for predicting therapy adherence, the method comprising: using a processor connected to a display: providing a clinician user interface on the display, the clinician user interface including an exercise creation user interface component and a protocol routine selection user interface component; receiving selection of a plurality of exercise items via the protocol routine selection user interface component to create a routine for a patient; automatically populating a patient calendar to be displayed on a patient user interface, the patient calendar including information about the routine; receiving patient adherence information for the patient; determining, based at least in part on the patient adherence information, a likelihood that the patient will adhere to the routine; modifying the routine to create a modified routine based on the likelihood transgressing a threshold; and update the patient calendar to include, the modified routine.

In Example 14, the subject matter of Example 13 includes, wherein the exercise creation user interface component includes a video creation component and an animation component, the video creation component selectable to record video of a clinician performing an exercise and the animation component selectable to create an animated exercise.

In Example 15, the subject matter of Examples 13-14 includes, wherein the clinician user interface is configured to display a video of the patient performing an exercise.

In Example 16, the subject matter of Examples 13-15 includes, wherein the plurality of exercise items include at least one exercise from a predefined list and at least one exercise created using the exercise creation user interface component.

In Example 17, the subject matter of Examples 13-16 includes, wherein the routine includes the plurality of exercise items in an order.

Example 18 is at least one machine-readable medium including instructions for receiving information, which when executed by a machine, cause the machine to: provide a clinician user interface on a display of the machine, the clinician user interface including an exercise creation user interface component and a protocol routine selection user interface component; receive selection of a plurality of exercise items via the protocol routine selection user interface component to create a routine for a patient; automatically populate a patient calendar to be displayed on a patient user interface, the patient calendar including information about the routine; receive patient adherence information for the patient; determine, based at least in part on the patient adherence information, a likelihood that the patient will adhere to the routine; modify the routine to create a modified routine based on the likelihood transgressing a threshold; and update the patient calendar to include, the modified routine.

In Example 19, the subject matter of Example 18 includes, instructions to create a patient protocol, the patient protocol including information about the routine, a specified number of days to perform the routine, a specified number of times per day for each exercise in the plurality of exercise items in the routine, and at least one of education information, a questionnaire, or an assessment.

In Example 20, the subject matter of Example 19 includes, wherein the instructions to automatically populate the patient calendar include instructions to automatically populate the patient calendar using the patient protocol.

Example 21 is a system for predicting therapy adherence, the system comprising: a display; and a processor connected to the display, the processor to: provide a clinician user interface on the display, the clinician user interface including a protocol selection user interface component; receive selection of at least one exercise item via the protocol selection user interface component to create a protocol for a patient; automatically populate a patient calendar to be displayed on a patient user interface, the patient calendar identifying the at least one exercise item of the protocol on a specified day; receive past therapy performance information for the patient; determine, based at least in part on the past therapy performance information, that the patient is unlikely to adhere to the protocol as populated on the patient calendar; and output an alert for presenting on the display, the alert indicating that the patient is unlikely to adhere to the protocol.

In Example 22, the subject matter of Example 21 includes, wherein to receive selection of the at least one exercise item, the processor is further to receive selection of at least one education item, and wherein the patient calendar is to identify the at least one education item of the protocol on the specified day.

In Example 23, the subject matter of Examples 21-22 includes, wherein the clinician user interface further includes an exercise creation user interface component, the exercise creation user interface component including a video creation component and an animation component, the video creation component selectable to record video of a clinician performing an exercise and the animation component selectable to create an animated exercise.

In Example 24, the subject matter of Examples 21-23 includes, the processor is further to receive an input from a clinician via the clinician user interface on the display, the input indicating a modification to the protocol.

In Example 25, the subject matter of Examples 21-24 includes, the processor is further to repopulate the patient calendar with changes to the protocol based on the modification.

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A system for predicting therapy adherence, the system comprising:
a display; and
a processor connected to the display, the processor to:
provide a clinician user interface on the display, the clinician user interface including an exercise creation user interface component and a protocol routine selection user interface component;
receive selection of a plurality of exercise items via the protocol routine selection user interface component to create a routine for a patient;
automatically populate a patient calendar to be displayed on a patient user interface, the patient calendar including information about the routine;
receive patient adherence information for the patient;
determine, based at least in part on the patient adherence information, a likelihood that the patient will adhere to the routine;
modify the routine to create a modified routine based on the likelihood transgressing a threshold; and
update the patient calendar to include the modified routine.

2. The system of claim 1, wherein the exercise creation user interface component includes a video creation component and an animation component, the video creation component selectable to record video of a clinician performing an exercise and the animation component selectable to create an animated exercise.

3. The system of claim 1, wherein the clinician user interface is configured to display a video of the patient performing an exercise.

4. The system of claim 1, wherein the plurality of exercise items include at least one exercise from a predefined list and at least one exercise created using the exercise creation user interface component.

5. The system of claim 1, wherein the routine includes the plurality of exercise items in an order.

6. The system of claim 1, wherein the processor is further to create a patient protocol, the patient protocol including information about the routine, a specified number of days to perform the routine, a specified number of times per day for each exercise in the plurality of exercise items in the routine, and at least one of education information, a questionnaire, or an assessment.

7. The system of claim 6, wherein to automatically populate the patient calendar includes to automatically populate the patient calendar using the patient protocol.

8. The system of claim 1, wherein the patient adherence information is received via at least one of the patient user interface, the clinician user interface, or information stored in a database, and includes demographic information for the patient.

9. The system of claim 1, wherein to determine the likelihood, the processor is to determine the likelihood that the patient will adhere to the routine based at least in part on a number of exercises, a number of reps, or a number of days in the routine.

10. The system of claim 1, wherein to modify the routine, the processor is to reduce a number of reps, number of days, or number of exercises in the routine and wherein to update the patient calendar, the processor is to reduce the number of reps, the number of days, or the number of exercises shown in the patient calendar.

11. The system of claim 1, wherein the processor is further to receive patient feedback collected using the patient user interface, the patient feedback including information about at least one of an exercise of the plurality of exercise items, the routine, a pain rating, or a difficulty rating for the routine.

12. The system of claim 11, wherein the processor is further to provide, via the clinician user interface, the patient feedback including at least one recommendation for an adjustment to the routine.

13. A method for predicting therapy adherence, the method comprising:
using a processor connected to a display:
providing a clinician user interface on the display, the clinician user interface including an exercise creation user interface component and a protocol routine selection user interface component;
receiving selection of a plurality of exercise items via the protocol routine selection user interface component to create a routine for a patient;
automatically populating a patient calendar to be displayed on a patient user interface, the patient calendar including information about the routine;
receiving patient adherence information for the patient;
determining, based at least in part on the patient adherence information, a likelihood that the patient will adhere to the routine;
modifying the routine to create a modified routine based on the likelihood transgressing a threshold; and
update the patient calendar to include the modified routine.

14. The method of claim 13, wherein the exercise creation user interface component includes a video creation component and an animation component, the video creation component selectable to record video of a clinician performing an exercise and the animation component selectable to create an animated exercise.

15. The method of claim 13, wherein the clinician user interface is configured to display a video of the patient performing an exercise.

16. The method of claim 13, wherein the plurality of exercise items include at least one exercise from a predefined list and at least one exercise created using the exercise creation user interface component.

17. The method of claim 13, wherein the routine includes the plurality of exercise items in an order.

18. At least one non-transitory machine-readable medium including instructions for receiving information, which when executed by a machine, cause the machine to:
provide a clinician user interface on a display of the machine, the clinician user interface including an exercise creation user interface component and a protocol routine selection user interface component;
receive selection of a plurality of exercise items via the protocol routine selection user interface component to create a routine for a patient;
automatically populate a patient calendar to be displayed on a patient user interface, the patient calendar including information about the routine;
receive patient adherence information for the patient;
determine, based at least in part on the patient adherence information, a likelihood that the patient will adhere to the routine;
modify the routine to create a modified routine based on the likelihood transgressing a threshold; and
update the patient calendar to include the modified routine.

19. The at least one machine-readable medium of claim 18, further comprising instructions to create a patient protocol, the patient protocol including information about the routine, a specified number of days to perform the routine, a specified number of times per day for each exercise in the plurality of exercise items in the routine, and at least one of education information, a questionnaire, or an assessment.

20. The at least one machine-readable medium of claim 19, wherein the instructions to automatically populate the patient calendar include instructions to automatically populate the patient calendar using the patient protocol.

21. A system for predicting therapy adherence, the system comprising:
a display; and
a processor connected to the display, the processor to:
provide a clinician user interface on the display, the clinician user interface including a protocol selection user interface component;
receive selection of at least one exercise item via the protocol selection user interface component to create a protocol for a patient;
automatically populate a patient calendar to be displayed on a patient user interface, the patient calendar identifying the at least one exercise item of the protocol on a specified day;
receive past therapy performance information for the patient;
determine, based at least in part on the past therapy performance information, that the patient is unlikely to adhere to the protocol as populated on the patient calendar; and
output an alert for presenting on the display, the alert indicating that the patient is unlikely to adhere to the protocol.

22. The system of claim 21, wherein to receive selection of the at least one exercise item, the processor is further to receive selection of at least one education item, and wherein the patient calendar is to identify the at least one education item of the protocol on the specified day.

23. The system of claim 21, wherein the clinician user interface further includes an exercise creation user interface component, the exercise creation user interface component including a video creation component and an animation component, the video creation component selectable to record video of a clinician performing an exercise and the animation component selectable to create an animated exercise.

24. The system of claim 21, wherein the processor is further to receive an input from a clinician via the clinician user interface on the display, the input indicating a modification to the protocol.

25. The system of claim 21, wherein the processor is further to repopulate the patient calendar with changes to the protocol based on the modification.
